(19) United States
(12) Patent Application Publication
(10) Pub. No.: US 2015/0361317 A1
(43) Pub. Date: Dec. 17, 2015

(54) HOT MELT ADHESIVE

(71) Applicants: LUCITE INTERNATIONAL UK LIMITED, Hampshire (GB); LUCITE INTERNATIONAL, INC., Cordova, TN (US)

(72) Inventors: Andrew Henry JANOWICZ, Lakeland, TN (US); Donald Allan THOMAS, Washington, WV (US); Hal Patrick IVEY, West Chester, PA (US); Michael Stephen CHISHOLM, Cleveland (GB)

(21) Appl. No.: 14/763,479

(22) PCT Filed: Jan. 28, 2014
(86) PCT No.: PCT/GB2014/050215

§ 371 Date: Jul. 24, 2015

Related U.S. Application Data
(60) Provisional application No. 61/757,502, filed on Jan. 28, 2013.

(51) Int. Cl. C09J 175/04; C09J 133/10; B32B 37/12; B32B 37/06; B32B 37/08; C09J 7/02; C09J 5/06

(52) U.S. Cl. CPC C09J 175/04; C09J 7/0203; C09J 133/10; C09J 5/06; B32B 37/06; B32B 37/08; B32B 37/12; C09J 2433/00; C09J 2475/00

(57) ABSTRACT

The present invention provides a moisture-reactive hot melt adhesive composition. The composition comprises: (a) urethane prepolymer, derived from at least one polyol and at least one polyisocyanate, and having free isocyanate groups effective to cure the composition in the presence of moisture; and (b) acrylic(co)polymer, wherein the acrylic (co)polymer comprises one or more residues of an (alk)acrylate (co)monomer of formula (I) wherein the group R contains at least one cyclic, tertiary or quaternary carbon, R is attached to the group —C(O)O— via a cyclic or tertiary carbon atom and wherein R′ is a hydrogen or an alkyl group. The invention extends to use of an acrylic (co)polymer in a moisture reactive hot melt adhesive composition as a stringing reducing agent; a substrate comprising the moisture reactive hot melt adhesive composition; and a method of bonding materials together with the composition.

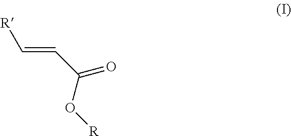

The present invention relates to the field of adhesives, in particular polyurethane hot melt adhesives. The present invention provides an improved hot melt adhesive composition comprising an acrylic polymer, a method of making said adhesive compositions, adhered surfaces comprising the adhesive composition and uses thereof.

The use of acrylic polymers to improve the performance of reactive hot melt adhesives is known from, for example, U.S. Pat. No. 5,021,507 and U.S. Pat. No. 5,866,656.

U.S. Pat. No. 6,465,104 describes how most reactive hot melt adhesives consist of a basic mixture of isocyanate terminated polyurethane pre-polymers that react with surface or ambient moisture to chain extend and form high molecular weight polyurethane polymer chains. The polyurethane prepolymers are typically prepared by reacting diols with diisocyanates. U.S. Pat. No. 5,021,507 further demonstrates that moisture curing urethane adhesives incorporating acrylic polymers display improved initial cohesive strength as well as improved strength after aging of the cured bond. Furthermore, U.S. Pat. No. 5,866,656 discloses that the use of hydroxyl functionalised acrylic polymers within hot melt adhesives promotes a desirable increase in green strength by becoming covalently bonded into the polyurethane structure.

However, problems can arise during the processing of such hot melt adhesive compositions containing acrylic polymers. One such problem is the effect known in the art as ‘stringing’. Stringing is the tendency of an ink, coating or adhesive formulation to form filaments or threads when transferring between surfaces or during delivery of the ink, coating or adhesive. Transfer surfaces or delivery devices may include rolls, plates, stencils, brushes, pads, spray guns, dip coating baths, rollers, laminators, and so on.

There are several known solutions to the problem of stringing, none of which have yet been effective due to their associated side effects on the quality of the compositions obtained. One commonly deployed solution for these problems is to reduce the viscosity of the paste or liquid formulation by adding additional solvent or reactive diluent. However, for solvent borne systems, this has the disadvantage of increasing the volatile organic content (VOC) of the formulation and the increased amount of solvent needs to be removed from the final system, resulting in longer drying times and/or increased energy costs. For VOC-free reactive systems, for example, in radiation curable adhesives, monomer/polymer ambient temperature curable adhesives, or moisture curable polyurethane hot melt adhesives, increasing the amount of reactive diluent reduces the overall concentration of acrylic polymer, thereby reducing its performance-enhancing contribution to the final composition.

Another approach is to reduce the molecular weight of the acrylic polymer within the composition, thereby altering the rheology of the resulting adhesive, particularly reducing the viscosity. This approach suffers from the disadvantages typically associated with reducing polymer molecular weight, such as reduced mechanical properties, reduced exterior durability, etc.

Accordingly, the problem remains of how to achieve reduced stringing in hot melt adhesives containing acrylic polymers without compromising other desirable features afforded by the inclusion of acrylic resins.

Surprisingly, it has been observed that incorporation of certain monomer residues containing bulky side groups into the acrylic polymer backbone can result in reduced stringing without having to reduce the molecular weight of the polymer or add extra solvent or reactive diluent.

According to a first aspect of the present invention, there is provided a moisture-reactive hot melt adhesive composition comprising:
(a) urethane prepolymer, derived from at least one polyol and at least one polyisocyanate, and having free isocyanate groups effective to cure the composition in the presence of moisture; and
(b) acrylic (co)polymer,
   wherein the acrylic (co)polymer comprises one or more residues of an (alk)acrylate (co)monomer of formula (I)

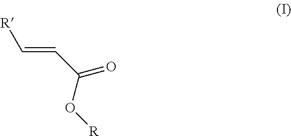

wherein the group R contains at least one cyclic, tertiary or quaternary carbon, R is attached to the group —C(O)O— via a cyclic or tertiary carbon atom and wherein R′ is a hydrogen or an alkyl group.

Preferably, the moisture reactive hot melt adhesive composition is a solvent free hot melt adhesive. By solvent free is meant less than 3% w/w solvent, more preferably, less than 2% w/w solvent, most preferably, less than 1% w/w solvent.

Preferably, the hot melt adhesive composition is a solid at 20° C.

By “moisture-reactive” is meant an adhesive that reacts with water with which it comes into contact, such as moisture in the atmosphere or water in the substrate to which the adhesive is applied; the reaction being such that the composition increases in molecular weight and/or crosslinks to thereby strengthen and/or cure the adhesive.

Preferably the or each R group independently contains from 4 to 40 carbon atoms, more preferably 4 to 18 carbon atoms, still more preferably 4 to 12 twelve carbon atoms, most preferably 4 to 10 ten carbon atoms. The R group may also include one or more hetero atoms, typically up to 5, more typically, up to 3 hetero atoms.

By “hetero” atoms herein is meant oxygen, sulphur or nitrogen.

Suitably, the or each R group independently may comprise an aliphatic, alicyclic or aromatic structure, or any combination thereof.

Suitable aliphatic or alicyclic structures include optionally substituted, saturated or unsaturated cyclic or branched structures, for example: t-butyl, t-pentyl, t-hexyl, t-heptyl, t-octyl, or any other t-alkyl structure; cyclopentyl, cyclohexyl, cycloheptyl, cyclooctyl, isobornyl, congressyl, adamantyl or any other alicyclic structure; or any combination of such groups including fused cyclic structures and cage structures.

Suitable aromatic structures include single or fused two, three or four ring structures, for example: phenyl, benzyl or napthyl structures which may be optionally substituted.

Optional substituents for any of the above groups are selected from one or more of the following groups: alkyl, hydroxyl, amino, halo, carboxyl, carboxylic acid, sulphonic acid, silyl, siloxyl, and epoxy groups.

In a particularly preferred embodiment, the or each R is substituted with hydroxyl groups such that they are moisture-functional and aid in the curing of the urethane prepolymer.

Suitably the (co)monomers forming the residues of formula (I) are selected from esters of (meth)acrylic acid.

Preferably the or each R in formula (I) is selected from one of the following structures: isobornyl, t-butyl, cyclohexyl, 4-t-butylcyclohexyl, 3,3,5-trimethylcyclohexyl, dihydrodicyclopentadienyl, adamantyl, phenyl and benzyl.

More preferably the or each R is selected from isobornyl or t-butyl. Accordingly, the group R is preferably bonded to the —C(O)O— group via a tertiary carbon atom. Furthermore, preferably, the R group is at least as sterically hindering as cyclohexyl, more preferably, at least as sterically hindering as t-butyl.

The group R′ may be hydrogen or an alkyl group. Suitable alkyl groups are C1-C8 alkyl groups which may be linear or branched, more preferably, C1-C4 alkyl groups, most preferably, methyl.

Preferably, therefore, the (co)monomers forming the residues of formula (I) are selected from one or more of the following: isobornyl methacrylate, t-butyl methacrylate, cyclohexyl methacrylate, 4-t-butylcyclohexyl methacrylate, 3,3,5-trimethylcyclohexyl methacrylate, dihydrodicyclopentadienyl methacrylate, adamantyl methacrylate, phenyl methacrylate, benzyl methacrylate, and any acrylate equivalents thereof.

More preferably therefore the (co)monomers are selected from one or more of isobornyl methacrylate or t-butyl methacrylate.

Optionally, in some embodiments of the present invention such as those covered by the claims, the above (co)monomers may be copolymerised with one or more other non-functional or functional monomers. Functional monomers are monomers having a reactive group/s that can participate in further reaction, bonding or interaction. Suitable functional monomers include those comprising groups such as, but not limited to: carboxylic acids; anhydrides; sulphonic acids; phosphonic acids; hydroxyl; primary/secondary/tertiary amines; epoxy; and acetoacetoxy groups.

Suitable non-functional and functional monomers include, but are not limited to: a further polyalkyl(alk)acrylate or (alk)acrylic acid such as methyl methacrylate, ethyl methacrylate, methyl acrylate, ethyl acrylate, n-butyl acrylate, iso-butyl acrylate, n-butyl methacrylate, iso-butyl methacrylate, hexyl methacrylate, hexyl acrylate, 2-ethylhexyl methacrylate, 2-ethylhexyl acrylate, lauryl methacrylate, lauryl acrylate, stearyl methacrylate, stearyl acrylate, methacrylic acid, acrylic acid; carboxy functional (alk)acrylates such as 2-carboxyethylacrylate, hydroxyl-functional (alk)acrylates such as 2-hydroxyethyl methacrylate, hydroxypropylmethacrylate, hydroxypropylethyl methacrylate, 2-hydroxyethyl acrylate, or hydroxypropyl acrylate; glycidyl methacrylate; sulphonyl functional (alk)acrylates such as 2-sulphoethylmethacrylate; amino functional (alk)acrylates such as N′N-dimethylaminoethyl methacrylate, N-t-butylaminoethyl methacrylate, N′,N-diethylaminoethyl methacrylate; epoxy functional (alk)acrylates such as 1-(2-methacryloxyethyl) imidazolidin-2-one; or acetoacetoxy functional (alk)acrylates such as 2-aceto acetoxy ethylmethacrylate; carboxylic acids such as crotonic, fumaric, maleic and itaconic acid; vinyl compounds such as styrene, alphamethylstyrene, vinyl pyrrolidinone, vinyl pyridine, vinyl acetate, monomethyl maleate, monomethyl itaconate, monobutyl maleate and maleic anhydride.

The composition of the present invention may include but preferably does not include an acrylic (co)polymer with tertiary alkyl amide functionality. By does not include in this context is meant contains less than 0.1% by weight of such monomers based on the weight of the acrylic (co)polymer, usually, less than 0.01% by weight.

In preferred embodiments of the present invention, including all those covered by the claims, the (co)monomers forming the residues of formula (I) are copolymerised with one or more of the following non-functional monomers: methyl methacrylate, n-butyl methacrylate, and methacrylic acid.

The acrylic (co)polymer may be formulated and polymerised so as to produce a wide range of glass transition temperature (Tg) values (as measured by differential scanning calorimetry) between about −55° C. to 150° C., more preferably −20° C. to 125° C., still more preferably 15° C. to 105° C., most preferably 30° C. to 85° C.

The amount of the (co)monomers forming the residues of formula (I) that can be incorporated in the acrylic (co)polymer may vary depending on the desired application performance, and may be between around 1 to 100 wt % of the total monomers used in the polymerisation to prepare the acrylic (co)polymer. The amount of (co)monomer of the invention used is determined by the properties that the acrylic (co)polymer needs to demonstrate for the particular application. Such acrylic (co)polymer properties are well known to the skilled person and may include Tg, solubility, miscibility, exterior durability, hardness, mechanical properties, adhesion, optical properties, gloss, cost, etc.

In preferred embodiments of the present invention including all those covered by the claims, the amount of (co)monomer(s) forming the residues of formula (I) that are incorporated in the acrylic (co)polymer is between around 1 to 95 wt % of the total monomers used in the polymerisation to prepare the acrylic (co)polymer, more preferably between around 1 to 80 wt %, still more preferably between around 5 to 70 wt %, most preferably between around 5 to 60 wt %.

In preferred embodiments of the present invention including all those covered by the claims, the weight average molecular weight (Mw) of the acrylic (co)polymer may vary from between around 3,000 g/mole to around 2,000,000 g/mole, preferably from around 5,000 g/mole to between around 500,000 g/mole, most preferably from around 7,000 g/mole to between around 200,000 g/mole. The weight average molecular weight being determined by Gel Permeation Chromatography (also known as Size Exclusion Chromatography) calibrated against polystyrene standards and using tetrahydrofuran as solvent.

In preferred embodiments of the present invention including all those covered by the claims, the amount of acrylic (co)polymer used in the composition depends to a great extent on the specifics of the application and the desired performance. The acrylic (co)polymer and the polyurethane may be used as the only polymers in the composition or in combination with other polymers.

Preferably, the acrylic (co)polymer forms between 5 to 80 wt % of the moisture reactive hot melt adhesive composition, more preferably 10 to 60 wt %, still more preferably 15 to 40 wt %, most preferably around 20 to 30 wt % thereof.

The acrylic (co)polymer may be prepared using any suitable known polymerisation method, such as, but not limited to: bulk, suspension, emulsion, solution polymerisation or any derivative thereof.

The composition may suitably further comprise any necessary components for effecting polymerisation of the acrylic (co)polymer, such as initiators and chain transfer agents. Initiators and chain transfer agents suitable for free radical polymerisation of acrylic (co)polymers are well known to the skilled person.

Examples of suitable initiators include: azo compounds, peroxides, peroxyesters and persulfates, specifically, azobis(isobutyronitrile), azobis(2-methylbutyronitrile), azobis(2,4-dimethylvaleronitrile), azobis(4-cyanovaleric acid), dilauroyl peroxide, tert-butyl peroxyneodecanoate, dibenzyl peroxide, cumyl peroxide, tert-butylperoxy-2-ethyl hexanoate, tert-butyl peroxydiethyl acetate, tert-butyl peroxy benzoate, tert-butyl hydroperoxide, potassium persulphate, ammonium persulphate and sodium persulphate.

Examples of chain transfer agents for control of molecular weight include: thiol compounds, cobalt compounds, alphamethyl styrene dimer, and aliphatic alcohols. The thiol compounds include monofunctional and multifunctional thiols. Monofunctional thiols include, but are not limited to, propyl mercaptan, butyl mercaptan, hexyl mercaptan, octyl mercaptan, dodecyl mercaptan, thioglycollic acid, mercaptopropionic acid, alkyl thioglycollates, for example: 2-ethylhexyl thioglycollate, or octylthioglycollate, mercaptoethanol, thiolactic acid and thiobutyric acid. Multifunctional thiols include di, tri, tetra and higher functionality thiols.

Preferably the acrylic (co)polymer is prepared by suspension polymerisation. This approach has the advantage of delivering the product in spherical bead form, ideal for fast dissolution in solvents and reactive liquids. Suspension polymerisation of acrylic monomers is well known and has been described in a number of literature reviews, for example Suspension Polymerisation; H. G. Yuan, G. Kalfas, and W. H. Ray; JMS-REV. Macromol. Chem. Phys.; C31(2&3); 215-299; 1991.

Suspension polymerisation involves the polymerisation of monomers in a dispersed phase. The continuous phase is normally water. Suitable dispersing agents are well known in the art and include modified cellulose polymers (e.g. hydroxyethyl, hydroxypropyl, hydroxypropyl methyl), polyacrylic acid, polymethacrylic acid, partially and fully neutralised versions of these acids, poly(vinyl alcohol), poly(vinyl alcohol-co-vinyl acetate) copolymers amongst others. The dispersion of monomers in the continuous phase is normally agitated at high speed throughout the polymerisation process to help keep the dispersion stable, to enable good heat transfer between the continuous phase and the dispersed droplets or particles and to control bead particle size.

As the polymerisation proceeds, the monomers in the dispersed phase react to form polymer which remains in the dispersed phase in spherical bead form. The reaction temperature may vary according to the type of monomers and initiator which are used and is typically between 20 and 150° C., for example in the range 50-120° C. The particle size of the resultant polymer beads is typically between 10 microns and 800 microns, for example in the range 40 to 600 microns. Accordingly, in one embodiment the acrylic (co)polymer of the invention is in the form of beads between 10 microns and 800 microns, more preferably 40 to 600 microns.

The resultant acrylic (co)polymer can be used in the composition above for a moisture reactive hot melt adhesive composition that utilises urethane prepolymers according to the invention that react with surface or atmospheric moisture. Such moisture reactive hot melt adhesives are used for bonding a wide variety of materials, including wood, polymers, metal, fabrics, paper, cardboard, composites, glass, etc in applications such as construction of doors, windows, architectural panels, bonding components on the exterior and interior of vehicles, laminating of wood, bonding textiles, and so on.

As indicated above, the urethane prepolymer is formed from at least one polyol and at least one polyisocyanate.

A polyol is a compound having two or more hydroxyl groups. Suitable polyols include, for example, polyether polyols, polyester polyols, polyether ester polyols and/or polyester ether polyols, fatty polyols, and mixtures thereof.

Polyether polyols suitable for use in the present invention include polyoxy-C2-C6-alkylene polyols, including branched and unbranched alkylene groups. Examples of suitable polyether polyols include, for example, polyethylene glycol, polypropylene glycol, polytetramethylene glycol or random or block copolymers of these polyethers, and mixtures thereof. Mixtures of the various suitable polyether polyols are also suitable for use in the present invention. The preferred polyether polyols are polypropylene glycols, also known as polypropyleneoxides. The polyether polyol preferably has a weight average molecular weight (“Mw” as measured by gel permeation chromatography), from 800 to 8,000, more preferably from 900 to 4,000.

Polyester polyols suitable for use in the present invention include those derived from diacids, or their monoester, diester, or anhydride counterparts, and diols. The diacids may be saturated C4-C12 aliphatic acids, including branched, unbranched, or cyclic materials, and/or C8-C15 aromatic acids. Examples of suitable aliphatic acids include, for example, succinic, glutaric, adipic, pimelic, suberic, azelaic, sebacic, 1,12-dodecanedioic, 1,4-cyclohexanedicarboxylic, and 2-methylpentanedioic acids. Examples of suitable aromatic acids include, for example, terephthalic, isophthalic, phthalic, 4,4′-benzophenone dicarboxylic, 4,4′-diphenylamide dicarboxylic acids, and mixtures thereof. The diols may be C2-C12 branched, unbranched, or cyclic aliphatic diols. Examples of suitable diols include, for example, ethylene glycol, 1,3-propylene glycol, 1,2-propylene glycol, 1,4-butandediol, neopentyl glycol, 1,3-butandediol, hexanediols, 2-methyl-2,4-pentanediol, cyclohexane-1,4-dimethanol, 1,12-dodecanediol, diethylene glycol, and mixtures thereof. Mixtures of the various suitable polyester polyols are also suitable for use in the present invention. The preferred polyester polyols are 1,6 hexanediol adipate; 1,6 hexanediol neopentyl glycol adipate; neopentyl glycol adipate and mixtures thereof. The polyester polyol(s) preferably has a weight-average molecular weight (“Mw” as measured by gel permeation chromatography) from 250 to 8,000, more preferably 300 to 6,000, even more preferably 400 to 5,000, and most preferably 500 to 4,000.

In some embodiments of the present invention, the components include at least one fatty polyol. “Fatty” means herein any compound that contains one or more residues of fatty acids. Fatty acids are well known in the art. Fatty acids are long-chain carboxylic acids, with chain length of at least 4 carbon atoms. Typical fatty acids have chain length of 4 to 18 carbon atoms, though some have longer chains. Linear, branched, or cyclic aliphatic groups may be attached to the long chain. Fatty acid residues may be saturated or unsaturated, and they may contain functional groups, including for example alkyl groups, epoxide groups, halogens, sulfonate groups, or hydroxyl groups, that are either naturally occurring or that have been added. Suitable fatty polyols include, for example, fatty acids, esters of fatty acids, amides of fatty acids, and mixtures thereof, as long as the compound is a polyol. Further examples of suitable fatty polyols include, for example, dimers, trimers, oligomers, or polymers of fatty acids; dimers, trimers, oligomers, or polymers of esters of fatty acids; dimers, trimers, oligomers, or polymers of amides of fatty acids; dimers, trimers, oligomers, or polymers of mixtures of fatty acids, esters of fatty acids, and amides of fatty acids; or mixtures of such dimers, trimers, oligomers, or polymers, as long as the fatty compound is a polyol. The hydroxyl functions of a suitable fatty polyol may reside on the fatty acid residue, on other parts of the molecule, or on both.

In embodiments of the present invention in which fatty polyols are used, some preferred fatty polyols are castor oil, the products of hydroxylation of unsaturated or polyunsaturated natural oils, the products of hydrogenations of unsaturated or polyunsaturated polyhydroxyl natural oils, polyhydroxyl esters of alkyl hydroxy fatty acids, polymerized natural oils, and alkylhydroxylated amides of fatty acids. More preferred are castor oil, hydroxylated soybean oil, hydrogenated castor oil, polymerized castor oil, hydroxy ethyl ricinoleate, and hydroxy ethyl ricinoleamide. Most preferred is castor oil.

In the practice of the present invention, the preferred polyols are polyether polyols, polyester polyols, fatty polyols, and mixtures thereof. More preferred is at least one polyether polyol, at least one polyester polyol or a mixture thereof. When polyether polyol(s) and polyester polyol(s) are both used, the preferred weight ratio of polyether polyols to polyester polyols is from 0.1:1 to 20:1, more preferred is 0.5:1 to 10:1, most preferred is 0.8:1 to 5:1. When fatty polyol(s) are used in addition to other polyols, the preferred weight ratio of fatty polyols to all other polyols is 0.005:1 to 5:1, more preferred is 0.01:1 to 1:1, and most preferred is 0.02:1 to 0.1:1.

Suitable polyisocyanate compounds include any isocyanate functional compound containing at least two isocyanate groups, such as, but not limited to: aromatic polyisocyanates, aliphatic polyisocyanates, cycloaliphatic polyisocyanates or any combination thereof. Preferably the polyisocyanate used is an aromatic polyisocyanate, for example: 2,4-toluene diisocyanate, 2,6-toluene diisocyanate, 1-methoxy-2,4-phenylene diisocyanate, 4,4′-dimethyl-diphenylmethane tetraisocyanate, 3,3′-dimethoxy-4,4′-biphenyl diisocyanate, 3,3′-dimethyl-4,4′-biphenyl diisocyanate, 3,3′-dimethyl-4,4′-diphenylmethane diisocyanate, naphthalene-1,5-diisocyanate (1,5-NDI), naphthalene-1,4-diisocyanate (1,4-NDI), 4,4′-diphenylmethane-diisocyanate (4,4′-MDI), 2,4′-diphenylmethane-diisocyanate (2,4′-MDI), xylylenediisocyanate (XDI), 2,2-diphenylpropane-4,4′-diisocyanate, p-phenylene diisocyanate, m-phenylene diisocyanate, diphenyl-4,4′-diisocyanate, diphenylsulphone-4,4′-diisocyanate, 1-chlorobenzene-2,4-diisocyanate, 4,4′,4″-triisocyanato-triphenyl-methane, 1,3,5-triisocyanato-benzene, 2,4,6-triisocyanato-toluene and furfurylidene diisocyanate. Examples of suitable cycloaliphatic polyisocyanates include 4,4′-dicyclohexylmethane diisocyanate (H12MDI), 3,5,5-trimethyl-3-isocyanatomethyl-1-isocyanato-cyclohexane (isophorone-diisocyanate, IPDI), cyclohexane-1,4-diisocyanate, cyclohexane-1,2-diisocyanate, hydrogenated xylylene diisocyanate (H6XDI), m- or p-tetramethylxylylene diisocyanate (m-TMXDI, p-TMXDI) and diisocyanate from dimer acid. Examples of aliphatic isocyanates include hexane-1,6-diisocyanate (HDI), 2,2,4-trimethylhexane-1,6-diisocyanate, 2,4,4-trimethylhexane-1,6-diisocyanate, butane-1,4-diisocyanate and 1,12-dodecane diisocyanate (C12DI). Examples of polymeric diisocyanates include polymethylene polyphenylene polyisocyanate. More preferably, the polyisocyanate used is 4,4′-diphenylmethane-diisocyanate, 2,4′-diphenylmethane-diisocyanate or mixtures thereof.

Polyisocyanates are used in the preparation of the urethane prepolymer, preferably only diisocyanates are used in the urethane prepolymer. However, optionally a small amount of higher functional isocyanates may be used, for example triisocyanates. Preferably a maximum of 10% by weight of the total polyisocyanate used to form the prepolymer is a higher polyisocyanate.

Preferably the urethane prepolymer has an isocyanate content of from about 0.25 to 15%, more preferably from about 0.5 to 10%, still more preferably from about 1 to 7%, most preferably from about 1.5 to 5%, wherein the isocyanate content is determined by the % of NCO bonds. A suitable method for determination of isocyanate content is ISO 14896:2009 Method B.

Preferably the composition comprises around 20 to 95 wt % urethane prepolymer, more preferably around 40 to 90 wt %, still more preferably around 60 to 85 wt %, most preferably around 70 to 80 wt % total uncured composition.

Preferably the urethane prepolymer is formed from around 5 to 35% polyisocyanate compound by weight and 95 to 65% polyols by weight.

Preferably the free isocyanate is derived from the polyisocyanate used to prepare the urethane prepolymer.

Preferably the composition comprises less than around 5 wt % free isocyanate, more preferably less than around 4 wt %, still more preferably less than around 3.5 wt %, most preferably less than around 3 wt %.

Optional further additives may be included in the hot melt adhesive composition. Suitable additives include: catalysts, stabilisers, tackifying resins, fillers, pigments, plasticisers, adhesion promoters, flame retardants, conductive agents, rheology improvers or any combination thereof.

Suitable catalysts include any chemical which accelerates the formation of the urethane prepolymer prior to formation of the hot melt adhesive composition, during production of the hot melt adhesive composition, or after application of the hot melt adhesive composition. For example: dibutyl tin dilaurate, dibutyl tin diacetate, dioctyl tin diacetate, dibutyl tin maleate, tin(II) octoate, tin(II) phenolate, acetyl acetonates of divalent and tetravalent tin, tetramethyl butane diamine, bis-(dimethylaminoethyl)-ether, 1,4-diazabicyclooctane (DABCO), 1,8-diazabicyclo-(5.4.0)-undecane, 2,2′-dimorpholinodiethyl ether, dimethyl piperazine or any mixtures thereof.

Suitable stabilisers include any chemical which stabilises the viscosity of the urethane prepolymer and/or any chemical that protects the urethane prepolymer from degradation by, for example, oxidation, UV radiation, or hydrolysis. For example: benzoyl chloride, toluene sulfonyl isocyanate, phosphoric acid, phosphorous acid, sterically hindered phenols, thioethers, substituted benzotriazoles, carbodiimides or any mixtures thereof.

Suitable tackifying resins include any chemical which improves the stickiness of the surface of the hot melt adhesive. For example: abietic acid, abietic acid esters, terpene resins, terpene/phenol resins, hydrocarbon resins or any combination thereof.

Suitable fillers include, for example: silicates, talcum, calcium carbonates, clays, carbon black or any combination thereof.

Suitable rheology improvers include any chemical that improves sagging of the hot melt adhesive. For example: pyrogenic (fumed) silicas, urea derivatives and fibrillated, pulp chopped fibers or any combination thereof.

Suitable adhesion promoters are similar to the abovementioned tackifying resins in that they cover any appropriate chemical which improves the bond of the hot melt adhesive to a surface. For example: organofunctional silanes such as 3-glycidyl-oxypropyl-trialkoxysilane or isocyanatoethyl trisalkoxysilane, epoxy resins, melamine resins, phenolic resins or any combination thereof.

Preferably the composition comprises optional additives in an amount of between 0-40% wt, more preferably in an amount of between 0-20% wt, still more preferably in an amount 0-10% wt, most preferably in an amount of around 0-5% wt.

Suitably, the composition does not generally comprise any organic solvents, more preferably any solvents, still more preferably the composition is VOC-free.

Suitably, the moisture-reactive hot melt adhesive composition may be prepared by any known method in the art. One method comprises the steps of mixing, typically, dissolving, the acrylic (co)polymer in the polyols then reacting this with the polyisocyanates and adding any additives. A modified method comprises the steps of dissolving the acrylic (co)polymer in some of the polyols, reacting with the polyisocyanates whilst adding the rest of the polyols and any additives.

Preferably the hot melt adhesive is prepared by the former method which advantageously maintains the viscosity of the mixture at a lower level making the mixture more workable and reducing the risk of gelation.

According to a second aspect of the present invention there is provided use of an acrylic (co)polymer in accordance with the first aspect of the present invention in a moisture reactive hot melt adhesive composition as a stringing reducing agent.

Preferably stringing is reduced by at least 30%, more preferably by at least 60%, still more preferably by at least 70%, most preferably by around 80% wherein the stringing behaviour of the hot melt adhesive is assessed by the method as described in the examples below and by comparison with a reference acrylic (co)polymer having a monomer formulation according to comparative example 1 and a weight average molecular weight Mw broadly equivalent thereto, for example +/−10%, and determined in the same manner.

According to a third aspect of the present invention there is provided a substrate comprising the moisture reactive hot melt adhesive composition of the first aspect of the present invention.

According to a fourth aspect of the present invention there is provided a method of bonding materials together comprising the steps of:

(a) heating the moisture reactive hot melt adhesive composition of the first aspect of the present invention;
(b) applying the heated composition onto a first substrate;
(c) contacting a second substrate with the said applied adhesive composition; and
(d) cooling the composition such that it solidifies and effects bonding of the first and second substrates together.

Chain extenders may also be used in the polyurethane hot melt adhesives according to the invention. Such chain extenders are well known to the skilled person. Generally, the chain extenders may be low molecular weight hydroxyl and amine terminated compounds. The choice of chain extender depends on the properties required in the final adhesive. Preferred chain extenders may be selected from one or more of ethylene glycol, diethylene glycol, triethylene glycol, tetraethylene glycol, propylene glycol, dipropylene glycol, tripropylene glycol, 1,3-propanediol, 1,3-butanediol, 2,3-butanediol, neopentylglycol, 1,4-dihydroxymethylcyclohexane, 1,4-butanediol, 1,6-hexanediol, hydroquinone bis(2-hydroxyethyl) ether, ethylenediamine, hexamethylenediamine, 1,4-cyclohexanediamine, ethanolamine, diethanolamine, methyldiethanolamine, diethyltoluenediamine, phenyldiethanolamine, 1,4-bis(2-hydroxyethoxy)benzene, 4,4′-(propane-2,2-diyl)diethoxyphenyl, 4,4′-(propane-2,2-diyl)dipropoxyphenyl, 1,4-benzenedicarboxylic acid-bis(2-hydroxyethyl)ester, N,N′-bis(2-hydroxyethyl)butanediamide, N,N′-bis(methyl,(2-hydroxyethyl))butanediamide and 2-methylpropane-1,3-diol. The chain extenders may be added in the range 0-15% by weight of the composition, more typically, 0 or 1-10% by weight.

The term ‘cyclic carbon’ as used hereinabove refers to a carbon atom located within a ring structure.

The term ‘quaternary carbon’ as used herein generally refers to a carbon atom which is bonded to four other carbon atoms.

The term ‘tertiary carbon’ as used herein generally refers to a carbon atom which is bonded to three other carbon atoms.

The term ‘hot melt adhesive’ as used herein generally refers to a class of adhesives which are supplied as a solid at room temperature and flow upon heating to allow application to one or more substrate(s). Upon cooling the adhesive regains a solid form and moisture cures to bond to the substrate(s).

Polyurethane hot melt adhesives are adhesives whose polymeric constituents comprise urethane groups and reactive isocyanate groups. The adhesives are solid at room temperature and are applied to substrates after heating, generally, in the form of a melt. Cooling of the heated adhesive results initially in rapid physical setting of the adhesive followed by a chemical reaction of the available isocyanate groups with moisture to form a cross-linked adhesive. It is only after the completion of the chemical reaction of isocyanate groups with moisture and subsequent crosslinking that the adhesive achieves its final application performance.

The term ‘urethane prepolymer’ as used herein refers to a polymer of a polyol and a polyisocyanate compound having reactive isocyanates groups. Generally, the prepolymer is terminated by reactive isocyanate groups.

The term ‘stringing’ as used herein refers to a condition occurring during transfer of adhesive between substrates and applicators characterised by incomplete transfer of the adhesive, resulting in the formation of webs, wisps, threads, or filaments between the substrate and the applicator.

The use of the term (alk), (meth) etc in (alk)acrylate, (alk)acrylic, (meth)acrylate, (meth)acrylic or the like refers to the option of the “alk” or “meth” group respectively. Similarly, a “(co)polymer” may be a homo-, co-, ter- or higher copolymer and merely refers to the absence of or presence of one or more types of comonomer residues in the polymer.

General references to “acrylic (co)polymer” herein refer to an (alk)acrylate or (alk)acrylic acid monomer residue containing polymer. Generally, however, at least 50% of the monomer residues in an acrylic (co)polymer will be (alk)acrylate or (alk)acrylic acid monomer residues.

### EXAMPLES

### Preparative Method

General description of preparation of acrylic (co)polymer by suspension polymerisation: Polymers were prepared by suspension polymerisation of an acrylic monomer mixture in the presence of chain transfer agent (e.g. n-dodecyl mercaptan), a free radical initiator (e.g. azobis(isobutyronitrile)) and a dispersant (e.g. hydroxyethyl cellulose) dissolved in deionised water. In a typical preparation, 20,000 g of deionised water and 50 g of hydroxyethyl cellulose were added to a reactor fitted with baffles to enhance the degree of agitation. The flask was agitated with a stainless steel stirrer rotating at 440 rpm. The chain transfer agent, n-dodecyl mercaptan (14.59 g), was dissolved in the monomer mixture (10,000 g) and then added to the reaction flask followed by 50.00 g of azobis(isobutyronitrile) initiator. The reactor was then heated to 90° C. The reaction was allowed to proceed until the polymerisation exotherm began to subside, whereupon the reactor contents were heat treated at 90° C. for 20 minutes to ensure the polymerisation had progressed to completion. The reactor contents were then cooled and the polymer beads were filtered, washed and dried in either an oven or in a fluid bed dryer.

### Characterisation:

The molecular weight was measured by gel permeation chromatography using polystyrene standards for calibration. Tetrahydrofuran was used as the mobile phase. The weight average molecular weight (Mw), number average molecular weight (Mn) and the polydispersity (Mw/Mn) were measured.

Bead particle size was measured by a Microtrac laser diffraction particle sizer and expressed as d50 (the size in microns that splits the particle size distribution with half above and half below this size).

Glass transition temperature (Tg onset) was measured by differential scanning calorimetry (DSC).

### Comparative Example 1

An acrylic (co)polymer was prepared for comparative purposes by the preparative method above. This (co)polymer did not include any (co)monomer residues of formula (I). The monomers used were methyl methacrylate (MMA), n-butyl methacrylate (nBMA) and methacrylic acid (MAA). Table 1 provides the composition of the 10,000 g monomer charge used in the polymerisation and the properties of the resultant polymer.

TABLE 1

| | | | | | | | Tg, | |
|---|---|---|---|---|---|---|---|---|
| | | | | | | | onset | Particle |
| | MMA | nBMA | MAA | | | | value | size, d50 |
| | (% wt) | (% wt) | (% wt) | Mw | Mn | Mw/Mn | (° C.) | (microns) |
| Comparative | 39.7 | 59.7 | 0.6 | 100,176 | 52,457 | 1.91 | 56 | 191 |
| Example 1 | | | | | | | | |

### Examples 1 to 3

Examples 1 to 3 involve the synthesis of an acrylic (co)polymer according to the preparative method based on methyl methacrylate (MMA), n-butyl methacrylate (nBMA), methacrylic acid (MAA) and t-butyl methacrylate as the (co)monomers. Table 2 provides the composition of the 10,000 g monomer charge used in the polymerisation and the properties of the resultant polymer.

TABLE 2

| | | | | | | | | Tg, | |
|---|---|---|---|---|---|---|---|---|---|
| | | | | | | | | onset | Particle |
| | MMA | nBMA | tBMA | MAA | | | | value | size, d50 |
| | (% wt) | (% wt) | (% wt) | (% wt) | Mw | Mn | Mw/Mn | (° C.) | (microns) |
| Example 1 | 29.7 | 59.7 | 10.0 | 0.6 | 95,713 | 49,509 | 1.93 | 52 | 131 |
| Example 2 | 19.7 | 59.7 | 20.0 | 0.6 | 93,683 | 48,088 | 1.95 | 51 | 142 |
| Example 3 | — | 59.7 | 39.7 | 0.6 | 93,007 | 48,485 | 1.92 | 44 | 98 |

### Examples 4 to 6

Examples 4 to 6 involve the synthesis according to the preparative method of acrylic (co)polymers based on methyl methacrylate (MMA), n-butyl methacrylate (nBMA), methacrylic acid (MAA) and isobornyl methacrylate (iBoMA) as the (co)monomer containing a side group according to the present invention. Table 3 provides the composition of the 10,000 g monomer charge used in the polymerisation and the properties of the resultant polymer.

TABLE 3

| | | | | | | | | Tg, | |
|---|---|---|---|---|---|---|---|---|---|
| | | | | | | | | onset | Particle |
| | MMA | nBMA | iBoMA | MAA | | | | value | size, d50 |
| | (% wt) | (% wt) | (% wt) | (% wt) | Mw | Mn | Mw/Mn | (° C.) | (microns) |
| Example 4 | 29.7 | 59.7 | 10.0 | 0.6 | 101,611 | 51,528 | 1.97 | 58 | 162 |
| Example 5 | 19.7 | 59.7 | 20.0 | 0.6 | 100,635 | 51,630 | 1.95 | 58 | 123 |
| Example 6 | — | 59.7 | 39.7 | 0.6 | 106,700 | 56,114 | 1.90 | 62 | 141 |

### Assessment of Stringing Behaviour

The stringing behaviour of the acrylic (co)polymers was assessed in the following way. The acrylic (co)polymers of comparative example 1, example 3 and 6 were separately dissolved in n-butyl acetate to make 40% solids solutions. These resins have similar Mw and differ only in composition. Coatings of approximately 200 microns wet thickness were then coated on a metal surface at ambient temperature (20-23° C.). After allowing the solvent in the coatings to partly evaporate for 30 seconds, a 1 cm diameter metal rod was then gently pressed onto the surface of the coatings and lifted upwards. In each case, the coating adhered to the bottom of the metal rod and strings of acrylic resin were pulled upwards. The process of gently pressing the rod onto the surface of the coatings and lifting upwards was repeated five times within the course of 1 minute and the stringing behaviour assessed. The number and thickness of the acrylic resin strings pulled up by the metal rod was then recorded and a qualitative score assigned, where 5=high number of strings of high thickness and 1=low number of strings of low thickness.

Comparative example 1=score 5
Example 3=score 3
Example 6=score 1
It can be seen that the acrylic resins of examples 3 and 6, which contain a side group in accordance with the invention, both display reduced stringing behaviour over the comparative example 1.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A moisture-reactive hot melt adhesive composition comprising:
(a) urethane prepolymer, derived from at least one polyol and at least one polyisocyanate, and having free isocyanate groups effective to cure the composition in the presence of moisture; and
(b) acrylic (co)polymer,
wherein the acrylic (co)polymer comprises one or more residues of an (alk)acrylate (co)monomer of formula (I) 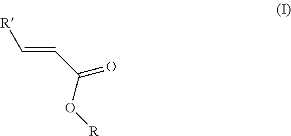
wherein the group R contains at least one cyclic, tertiary or quaternary carbon, R is attached to the group —C(O)O— via a cyclic or tertiary carbon atom and wherein R′ is a hydrogen or an alkyl group.

2. Use of an acrylic (co)polymer according to claim 1 in a moisture reactive hot melt adhesive composition as a stringing reducing agent.

3. A substrate comprising the moisture reactive hot melt adhesive composition of claim 1.

4. A method of bonding materials together comprising the steps of:
(a) heating the moisture reactive hot melt adhesive composition of claim 1;
(b) applying the heated composition onto a first substrate;
(c) contacting a second substrate with the said applied adhesive composition; and
(d) cooling the composition such that it solidifies and effects bonding of the first and second substrates together.

5. A composition, use, substrate or method according to claim 1, wherein the moisture reactive hot melt adhesive composition is a solvent free hot melt adhesive, and wherein by solvent free is meant less than 3% w/w solvent, more preferably, less than 2% w/w solvent, most preferably, less than 1% w/w solvent.

6. A composition, use, substrate or method according to claim 1, wherein the hot melt adhesive composition is a solid at 20° C.

7. A composition, use, substrate or method according to claim 1, wherein the or each R group independently contains from 4 to 40 carbon atoms, more preferably 4 to 18 carbon atoms, still more preferably 4 to 12 twelve carbon atoms, most preferably 4 to 10 ten carbon atoms.

8. A composition, use, substrate or method according to claim 1, wherein the R group may also include one or more hetero atoms, typically up to 5, more typically, up to 3 hetero atoms.

9. A composition, use, substrate or method according to claim 1, wherein the or each R group independently may comprise an aliphatic, alicyclic or aromatic structure, or any combination thereof.

10. A composition, use, substrate or method according to claim 9, wherein the aliphatic or alicyclic structures include optionally substituted, saturated or unsaturated cyclic or branched structures, for example: t-butyl, t-pentyl, t-hexyl, t-heptyl, t-octyl, or any other t-alkyl structure; cyclopentyl, cyclohexyl, cycloheptyl, cyclooctyl, isobornyl, congressyl, adamantyl or any other alicyclic structure; or any combination of such groups including fused cyclic structures and cage structures; and/or the aromatic structures include single or fused two, three or four ring structures, for example: phenyl, benzyl or napthyl structures which may be optionally substituted; and optional substituents for any of the above groups are selected from one or more of the following groups: alkyl, hydroxyl, amino, halo, carboxyl, carboxylic acid, sulphonic acid, silyl, siloxyl, and epoxy groups.

11. A composition, use, substrate or method according to claim 1, wherein the or each R is substituted with hydroxyl groups such that they are moisture-functional and aid in the curing of the urethane prepolymer.

12. A composition, use, substrate or method according to claim 1, wherein the (co)monomers forming the residues of formula (I) are selected from esters of (meth)acrylic acid.

13. A composition, use, substrate or method according to claim 1, wherein the or each R in formula (I) is selected from one of the following structures: isobornyl, t-butyl, cyclohexyl, 4-t-butylcyclohexyl, 3,3,5-trimethylcyclohexyl, dihydrodicyclopentadienyl, adamantyl, phenyl and benzyl, more preferably the or each R is selected from isobornyl or t-butyl.

14. A composition, use, substrate or method according to claim 1, wherein the group R is bonded to the —C(O)O— group via a tertiary carbon atom.

15. A composition, use, substrate or method according to claim 1, wherein the R group is at least as sterically hindering as cyclohexyl, more preferably, at least as sterically hindering as t-butyl.

16. A composition, use, substrate or method according to claim 1, wherein the group R′ is hydrogen or an alkyl group, preferred alkyl groups are C1-C8 alkyl groups which may be linear or branched, more preferably, C1-C4 alkyl groups, most preferably, methyl.

17. A composition, use, substrate or method according to claim 1, wherein the (co)monomers forming the residues of formula (I) are selected from one or more of the following: isobornyl methacrylate, t-butyl methacrylate, cyclohexyl methacrylate, 4-t-butylcyclohexyl methacrylate, 3,3,5-trimethylcyclohexyl methacrylate, dihydrodicyclopentadienyl methacrylate, adamantyl methacrylate, phenyl methacrylate, benzyl methacrylate, and any acrylate equivalents thereof, more preferably the (co)monomers are selected from one or more of isobornyl methacrylate or t-butyl methacrylate.

18. A composition, use, substrate or method according to claim 1, wherein the composition may include but preferably does not include an acrylic (co)polymer with tertiary alkyl amide functionality, by does not include in this context is meant contains less than 0.1% by weight of such monomers based on the weight of the acrylic (co)polymer, usually, less than 0.01% by weight.

19. A composition, use, substrate or method according to claim 1, wherein the (co)monomers forming the residues of formula (I) are copolymerised with one or more of the following monomers: methyl methacrylate, n-butyl methacrylate, and methacrylic acid.

20. A composition, use, substrate or method according to claim 1, wherein the amount of (co)monomer(s) forming the residues of formula (I) that are incorporated in the acrylic (co)polymer is between around 1 to 95 wt % of the total monomers used in the polymerisation to prepare the acrylic (co)polymer, more preferably between around 1 to 80 wt %, still more preferably between around 5 to 70 wt %, most preferably between around 5 to 60 wt %.

21. A composition, use, substrate or method according to claim 1, wherein the acrylic (co)polymer and the polyurethane (urethane pre-polymer) may be used as the only polymers in the composition or in combination with other polymers.

22. A composition, use, substrate or method according to claim 1, wherein the acrylic (co)polymer forms between 5 to 80 wt % of the moisture reactive hot melt adhesive composition, more preferably 10 to 60 wt %, still more preferably 15 to 40 wt %, most preferably around 20 to 30 wt % thereof.

23. A composition, use, substrate or method according to claim 1, wherein the acrylic (co)polymer may be prepared using any suitable known polymerisation method, such as, but not limited to: bulk, suspension, emulsion, solution polymerisation or any derivative thereof.

24. A composition, use, substrate or method according to claim 1, wherein the composition comprises around 20 to 95 wt % urethane prepolymer, more preferably around 40 to 90 wt %, still more preferably around 60 to 85 wt %, most preferably around 70 to 80 wt % total uncured composition.

25. A composition, use, substrate or method according to claim 1, wherein the composition does not generally comprise any organic solvents, more preferably any solvents, still more preferably the composition is VOC-free.
